(19) United States
(12) Patent Application Publication
(10) Pub. No.: US 2013/0303189 A1
(43) Pub. Date: Nov. 14, 2013

(54) Geolocation Of A Mobile Device In The Course Of A Law Enforcement Operation

(71) Applicant: World Emergency Network - Nevada Ltd., (US)

(72) Inventor: Christopher Ryan Bennett, St. Petersburg, FL (US)

(21) Appl. No.: 13/869,876

(22) Filed: Apr. 24, 2013

Related U.S. Application Data
(60) Provisional application No. 61/637,735, filed on Apr. 24, 2012.

(51) Int. Cl. H04W 4/02

(52) U.S. Cl. CPC H04W 4/02
USPC 455/456.2

(57) ABSTRACT

A geolocation system enables law enforcement officers to geolocate a mobile phone, or target device, during the course of police business. In a consented geolocation request, an officer requests, via the geolocation system, that the user of a target device be prompted to grant the officer permission to geolocate the target device. If the user allows the request, the officer may, in turn, geolocate the target device with the geolocation system. In a surreptitious geolocation request, the officer circumvents any request for user permission to grant the officer permission to geolocate the target device. Instead, the officer utilizes the geolocation system to generate a surreptitious request package which contains the necessary legal and situational information required to geolocate the target device without the user's consent. Once a submitted request is registered, the officer may geolocate the target device.

### CROSS REFERENCE TO RELATED APPLICATIONS

This application claims the benefit of U.S. Provisional Application 61/637,735, filed Apr. 24, 2012, which is incorporated by reference herein in its entirety.

### BACKGROUND

1. Field of Art

The present disclosure generally relates to the field of geolocating a mobile device and more specifically to expediting geolocation of the mobile device during the course of a law enforcement operation.

2. Background of the Invention

Police officers and other agents oftentimes need to geolocate a target mobile phone or other device during the course of their duties. Traditionally, obtaining permission to geolocate a target mobile phone during the course of a law enforcement operation requires the officer to manually request the location of the target from a service provider. The service provider manually processes the request and provides the officer with the location of the target mobile device.

Oftentimes, the service provider processes the request on the order of hours or days, in addition to commanding a non-trivial sum of money for processing the request. The time delay to process a request oftentimes negates the usefulness of locating the target mobile device for time sensitive investigations. Further, the service provider's charges prohibit the agency from geolocating a mobile device for lower priority investigations.

### SUMMARY

The above and other issues are addressed by a method and computer system for geolocating a target mobile, which may be provided by an agency service utilizing application programming interfaces to expedite lookup and return of a target device's location while meeting the applicable legal requirements for geolocating the target device. An embodiment of the method comprises receiving a request to locate a target device associated with a user from a monitoring device associated with an officer. The request includes properties identifying a transmitting number of the target device and the user of the target device. The request to locate the target devise is automatically processed in accordance with a set of rules governing the legality of locating the target device during the course of a law enforcement operation.

Automatically processing the request to locate the target device may comprise prompting the user of the target device to consent to the request to locate the target device. In turn, a text massage prompting the user of the target device for a response may be generated. The text message indicates the request properties and is transmitted to the target device. Text messages received from the target device are parsed to determine whether the user of the target device consents to the request to locate the target device.

Automatically processing the request to locate the target device may comprise automatically generating a legal document for authorizing the request to locate the target device. Generating the legal document may comprise identifying fields in the legal document and automatically populating one or more fields with the request properties. Additionally, login credentials of the officer may use used to populated one or more fields within the legal document with officer information. Any supporting legal documentation required for authorizing the officer to locate the target device may also be identified. In turn, a prompt may be transmitted to the monitoring device requesting the identified supporting legal documentation.

The location requests are registered with a location interface that identifies location information for the target device. The location of the target device may then be automatically transmitted to the monitoring device.

An embodiment of the system comprises a server having one or more processors and a non-transitory computer-readable storage medium storing computer program code. When executed, the computer program code causes the server to receive information in response to requests to locate a target device associated with a user from a monitoring device associated with an officer. The request includes properties identifying a transmitting number of the target device and the user of the target device. The request to locate the target devise is automatically processed in accordance with a set of rules governing the legality of locating the target device during the course of a law enforcement operation.

Automatically processing the request to locate the target device may comprise prompting the user of the target device to consent to the request to locate the target device. In turn, a text massage prompting the user of the target device for a response may be generated. The text message indicates the request properties and is transmitted to the target device. Text messages received from the target device are parsed to determine whether the user of the target device consents to the request to locate the target device.

Automatically processing the request to locate the target device may comprise automatically generating a legal document for authorizing the request to locate the target device. Generating the legal document may comprise identifying fields in the legal document and automatically populating one or more fields with the request properties. Additionally, login credentials of the officer may use used to populate one or more fields within the legal document with officer information. Any supporting legal documentation required for authorizing the officer to locate the target device may also be identified. In turn, a prompt may be transmitted to the monitoring device requesting the identified supporting legal documentation.

The location requests are registered with a location interface that identifies location information for the target device. The location of the target device may then be automatically transmitted to the monitoring device.

### BRIEF DESCRIPTION OF THE DRAWINGS

The teachings of the embodiments can be readily understood by considering the following detailed description in conjunction with the accompanying drawings.

FIG. 1 is a block diagram illustrating an example operating environment of an agency service for geolocating a target device, according to one example embodiment.

FIG. 2 is a block diagram illustrating a geolocation module according to one example embodiment.

FIG. 3 is an interaction diagram illustrating a method of geolocating a target device during the course of a law enforcement operation, according to one example embodiment.

FIG. 4A is an interaction diagram illustrating a method of processing a consensual location request, according to one example embodiment.

FIG. 4B is a flow chart illustrating an example messaging sequence for confirming a target device user's consent to a geolocation request, according to one example embodiment.

FIG. 5 is an interaction diagram illustrating a method of processing a surreptitious location request, according to one example embodiment.

FIG. 6 is an example form with fields for processing a surreptitious location request, according to one example embodiment.

FIGS. 7A, 7B and 7C are example user interfaces for geolocating a mobile device during the course of a law enforcement operation, according to one example embodiment.

### DETAILED DESCRIPTION

The Figures (FIG.) and the following description relate to preferred embodiments by way of illustration only. It should be noted that from the following discussion, alternative embodiments of the structures and methods disclosed herein will be readily recognized as viable alternatives that may be employed without departing from the principles of the embodiments.

Reference will now be made in detail to several embodiments, examples of which are illustrated in the accompanying figures. It is noted that wherever practicable, similar or like reference numbers may be used in the figures and may indicate similar or like functionality. The figures depict embodiments for purposes of illustration only.

### Overview

A geolocation system is provided for enabling police officers and other law enforcement agents (“officers”) to geolocate a mobile phone or other Location Based Services (LBS) enabled device (collectively, “target device”) during the course of police business. LBS may be used to geolocate a target mobile device of a criminal suspect, confidential informant, fugitive or even an officer. Traditionally, the geolocation process involved contacting the service provider or carrier of the mobile device such as a phone carrier or data services provider (collectively, communications service provider (CSP)) by email or fax to request the location of the target device, at which point the CSP reviews the request internally for approval. Responses, even if approving the request, could have delays measured in hours or days, and come accompanied with a costly bill to the law enforcement agency.

The geolocation system described herein, which may be provided by an agency supporting service, may utilize application programming interfaces (“APIs”) to expedite lookup and return of a target device's location while meeting the applicable legal requirements for geolocating the target device. Depending on the type of location request, the CSP, laws for officer conduct, agency, and/or due to variety of other factors, the legal requirements governing the officer's ability to locate the target device may differ. Accordingly, the geolocation system generates forms and automatically prompts officers to complete the applicable requirements according to a set of rules that ensure officers utilizing the system comply with best practices for geolocating a target device in the field.

One type of location request is a consented request. In a consented geolocation request, the officer requests, via the geolocation system, that the user of the target device grants the officer permission to geolocate the target device. The user may allow or deny the officer's request. If the user allows the request, the officer may, in turn, utilize the geolocation system to geolocate the target device. For example, the officer may utilize a consented geolocation request to determine the location of a confidential informant

Another type of location request is a surreptitious request. In a surreptitious geolocation request, the officer circumvents user permission to grant the officer permission to geolocate the target device. Instead, the officer utilizes the geolocation system to generate a surreptitious request package which contains the necessary legal and situational information required to geolocate the target device without the user's consent. For example, the officer may utilize a surreptitious geolocation request to determine the location of a prime suspect in a crime.

Once a submitted request is approved by the agency service and/or the CSP, the officer may then geolocate the target device. The agency service determines (e.g., in real-time) via one or more interfaces (e.g., a CSP or 3^{rd} party API) location information the target device and may subsequently transmit all or a portion of the collected real-time data over existing channels (e.g., a network) back to the agency, or another entity, such as a mobile device of the requesting officer utilized to monitor the location of the target device. For example, embodiments of the agency, agency service and/or other entities within the geolocation system receive the collected location data for storage and/or live streaming to an officer's monitoring device and records.

### Example Operating Environment for Implementing the Geolocation System

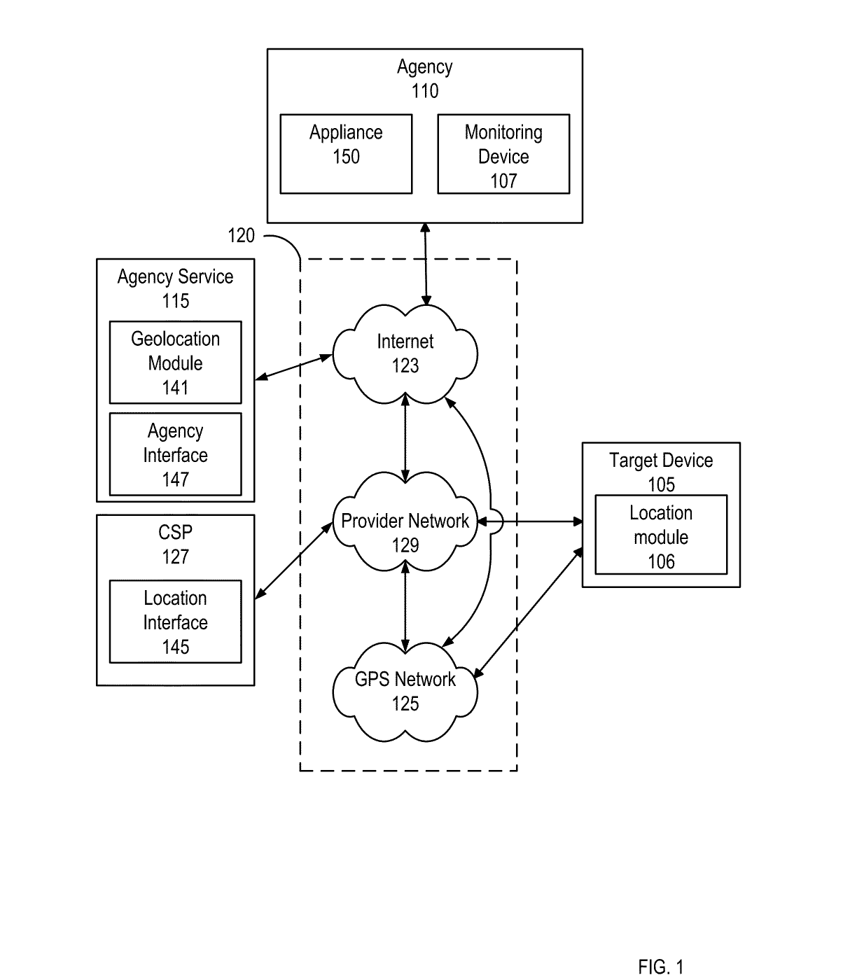

Figure (FIG. 1 is a block diagram illustrating an example operating environment of an agency service 115 for geolocating a target device 105, according to one example embodiment. As shown, the operating environment includes an agency 110, communications service provider (CSP) 127, monitoring device 107, target device 105 and a network 120 with components such as the internet 123, provider network 129 and global positioning system (GPS) network 125.

Agency 110 represents a collection of servers, desktop, notebook or tablet computers, mobile telephones and related storage mediums used by respective agency personnel for executing applications or modules to communicate with and receive data from the agency service 115 (e.g., via the agency interface 147) and other entities on the network 120. For example, agency 110 devices, such as monitoring device 107, may execute a web browser to access a web interface or execute a mobile or desktop application comprising one or more modules for communicating with the agency service 115 or other entity coupled to the network 120 to geolocate a target device 105. An agency 110 may also include data, telephonic and video infrastructure enabling data, audio and video communicability (e.g., internally and/or over the network 120) using a data network (e.g., TCP/IP), public switched telephone network (PSTN), short messaging service (SMS), voice over internet protocol (VoIP) or other communication protocol.

Monitoring devices 107 may connect to entities on the network 120 to obtain or present data associated with one or more geolocation requests for target devices 105. The monitoring device 107 may also be used to submit geolocation requests. Depending on the embodiment, a monitoring device 107 is a network 120 capable device that can be operated within an agency 110 or externally in the field. As referred to herein, a monitoring device 107 is a mobile or stationary device capable of connectivity (e.g., wireless or wired) to a network 120 such as an agency network, the internet, PSTN, GPS and/or provider network.

The monitoring device 107 is oftentimes a desktop computer or mobile device capable of collecting data and transmitting data (e.g., wired or wirelessly) over the network 120. Some examples of a monitoring device 107 as a mobile device include a mobile phone, tablet or notebook computer. Example embodiments of monitoring device 107 as a mobile phone include feature phones, smart phones or standard mobile phones. Accordingly, a given mobile phone or other device operated as a monitoring device 107 may not necessarily include or support all of the functionality ascribed herein to the monitoring device 107 or geolocation system due to inherent differences in device capabilities.

The target device 105 is oftentimes a mobile telephonic device capable of collecting data and transmitting data (e.g., wirelessly) over the network 120. Some examples of the target device 105 as a mobile telephonic device include a mobile phone, tablet or notebook computer. Example embodiments of the target device 105 as a mobile phone include feature phones, smart phones or standard mobile phones. As shown, the target device 105 includes a location module 106 that may utilize a variety of technologies to determine a position of the target device 105. The capabilities of the location module 106 executing on the target device 105 may differ based on device capabilities. For example, the location module 106 of one target device 107 may as best be used to determine its location based on the known location of a nearby cell tower within a provider network 129. Alternatively, the location module 106 executing on another target device 105 may be able to triangulate its location based on the coordinates of nearby cell towers within the provider network 129 and/or utilizing a GPS network 125. In one embodiment, the location module 106 employs assisted-GPS, which utilizes an internet 123 and/or provider network 129 connection to aid in determining its location using GPS network 125 satellites. For example, the location module 106 may communicate with a server on the network 120 (e.g., operated by the CSP 127 and/or a 3^{rd} Party) to quickly retrieve orbital data for GPS satellites or offload received data from GPS satellites for processing at the server. Some location modules 106 may also determine a location based on an address or location associated with a WiFi connection utilized by the target device 105 to connect to the network 120. Accordingly, a given mobile phone or other target device 105 to be geolocated may not necessarily include or support all of the functionality ascribed herein to the geolocation system due to inherent differences in device capabilities.

The provider network 129 may include servers, switches and other hardware and software for implementing, among other protocols and technologies, worldwide interoperability for PSTN communications including land-lines and 2G/3G/4G wireless protocols. The provider network 129 is managed by one or more communication service providers “CSPs” 127 that own telephone numbers for use on the PSTN and operate and service portions of the provider network 129. For example, a portion of the provider network 129 may be proprietary to a CSP 127, and include hardware such as wireless data and telephonic service devices (e.g., cellular towers, etc.) owned by the CSP that facilitate communications over the PSTN and internet 123. In some embodiments, the provider network 129 may also include CSP 127 managed WiFi hotspots for providing internet service 123 to their customers. Accordingly, the provider network 129 may include servers, switches and other hardware and software for communicating over the network 120 with CSPs 127 and other entities to handle network 120 traffic.

The CSP 127 owns telephone numbers (and/or internet protocol (IP) address ranges) for use on the provider network 129 and, in turn, manages network 120 traffic associated with those numbers when the corresponding devices are utilizing the provider network 129. Thus, the provider network 129 and CSP 127 provide mobile devices, such as the target device 105 and/or monitoring device 107, with the capability to transmit and receive data over the PSTN and internet 123.

Typically, a telephone number used on the provider network 129 directs to a given mobile device, VoIP device or land-line device having an associated number identity characterized by automatic number identification “ANI” information, or caller identification. VoIP phones and other IP based devices such as a modem may additionally (or alternatively) have an associated IP address that is leased on either a short term or long term basis from the CSP. For example, a home modem may utilize a short term lease (e.g., may change on modem power on/off) whereas a company server or VoIP device may have a long term lease (e.g., does not change). The CSP 127 may store customer information for telephone numbers and IP based devices authorized on the provider network 129.

Agency service 115 represents a collection of compute devices (e.g., servers) and related storage mediums that are configured for performing various activities such as coordinating the geolocation of target devices and storing data in support of the agency 110 and monitoring devices 107. For example, the agency service 115 may include one or more modules providing ascribed functionality to an agency 110 via an application programming interface (“API”) or web interface, collectively “the agency interface” 147. The agency service 115 may also include infrastructure for providing audio and video communicability (e.g., internally and/or over the network 120) within the monitoring interface using the public switched telephone network (“PSTN”), voice over internet protocol (“VoIP”) and video conferencing services.

In one embodiment, the agency service 115 receives requests via the agency interface 147 from the agency 110 or monitoring device 107 to geolocate the target device 105. The officer submitting the request may include number information for the target device 105 such as an area code (e.g., 555), country code (e.g., +44) and/or number (e.g., 403-7826), user information such as name, address, zip code or city, and/or associated CSP 127. In one embodiment, the agency service 115 processes the request based on a set of rules ensuring the officer complies with best practices for geolocating a target device in the field. Rules for complying with a given geolocation request may be stored at the agency service 115 and/or agency 110 associated with the officer making the request. For example, the agency service 115 may determine whether the request is a surreptitious or consensual request and process the requests according to the different legal requirements applicable to each request type. The agency service 115 may, in turn, approve the request and register the geolocation request with one or more CSPs 127 or a 3^{rd} Party Intermediary (not shown) that manages LBS for a number of CSPs. To register the request the agency service 115 may, for example, query a CSP 127 with number and user information received from the requesting officer along with any other associated data such as user consent and/or legal forms and verify a match of a CSP 127 record with the target device and associated user. Once the target device 105 has been registered with the CSP 127, the agency service 115 may request the target device's location.

In one embodiment, the CSP 127 includes a location interface 145 for registering location requests and determining the location of target devices 105. In one embodiment, the location interface 145 determines a target device's 105 location by polling the location module 106 of the target device for its current known location. The location interface 145 may also utilize network 120 devices such as wireless towers or nodes to determine the location of the target device 105. For example, the location interface 145 may store wireless broadcast identification information for the target device 105. In turn, the location interface 145 identifies the towers in range of the target device 105 and signal strength associated with the different towers. Based on the signal strength and location of the towers, the location interface 145 triangulates an estimated location of the target device. The location interface 145 may also utilize the GPS network 125 to determine the distance of three or more satellites to the target device 105 and triangulate the location of the target device 105.

In some embodiments, the location interface 145 utilizes multiple locating methods and combines them to produce a more accurate measurement. The location interface 145 may also determine a margin of error (e.g., 100 ft, 500 ft, 750 ft, etc) describing the accuracy of each measurement. The location interface 145 subsequently transmits the determined location information such as coordinates (e.g., latitude and longitude, or other proprietary coordinates) and the margin of error to the agency service 115. The determined location information may further include a heading and velocity of the target device 105.

In one embodiment, the agency service 115 communicates (e.g., over the network 120) with the CSP 127 location interface 145 to register location requests and geolocate target devices 105. In other embodiments, such as in cases where the agency service 115 does not have a direct relationship with a CSP 127, the agency service may communicate with a 3^{rd} Party Intermediary providing LBS for the CPS 127 to register location requests and geolocate target devices 105. Thus, the 3^{rd} Party Intermediary may also include a location interface 145 for servicing agency service 115 requests for a variety of CPSs 127. Accordingly, references made herein to connections between the agency service 115 and other entities with the location interface 145 of the CPS 127 are not so limited, and include embodiments where similar connections and processes may be carried out with a location interface of a 3^{rd} Party Intermediary. Additionally, in some embodiments, the agency service 115 may utilize 3^{rd} Party APIs for the sending and receiving of SMS text messages. For example, the agency service 115 may send a SMS message to a target device 105 for the user's consent to be located. Additionally, for example, the agency service 115 may send a SMS message to notify a monitoring device 107 when a given target device 107 may be located.

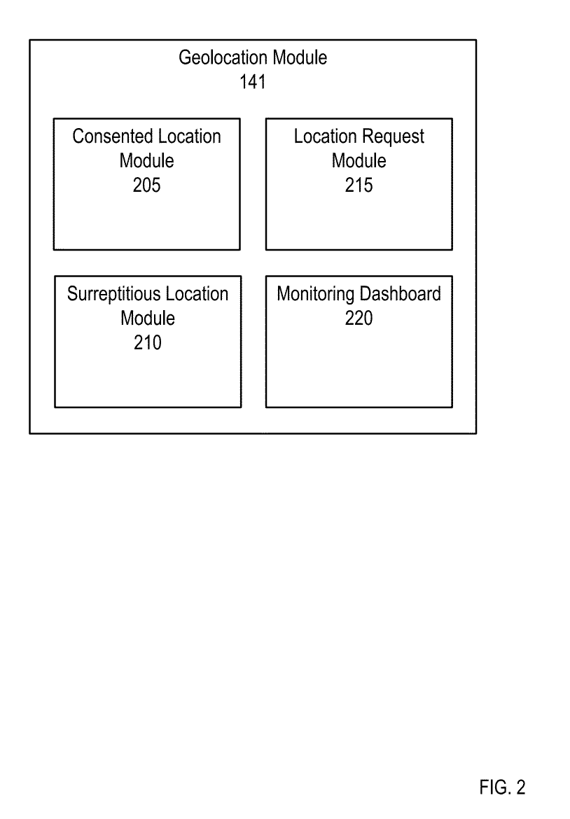

In some embodiments, the agency service 115 includes a geolocation module 141 that may be accessed via the agency interface 147 (e.g., via a web browser) to process geolocation requests and present locations of target devices 105. The agency service 115 may also provide functionality of the geolocation module 141 to the monitoring device 107 in the form of hardware and/or software in order to support collection of information for geolocation requests using monitoring device software and/or hardware. For example, a geolocation module 141 may execute on the monitoring device 107 to utilize features such as a camera, touch interface, keyboard and/or display to collect and present information for the officer. The geolocation module 141 on the monitoring device 107 may also format and transmit the collected data over the network 120, such as back to the agency service 115 (e.g., via the agency interface 147) or other entity. The agency service 115, in turn, may store the collected data locally and/or perform additional processing of the data. For example, a geolocation module 141 at the agency service 115 may verify data received from the monitoring device 107 prior to registering a geolocation request with a CSP 127 or accessing the location interface 145 to determine a location of the target device. Additionally, the agency service 115 may transmit the collected data to the agency 110 for record storage (e.g., in an appliance 150). The geolocation module 141 is described in more detail with reference to FIG. 2.

In one embodiment, the agency 110 includes an appliance 150 for storing geolocation request data, target device location history, and other collected or determined information. The appliance 150 may additionally store legal forms and/or text associated with the consensual and surreptitious requests. The appliance 150 may utilize the agency interface 147 provided by the agency service 115 for updating stored data at the appliance and/or the agency service 115. For example, the appliance 150 may be periodically updated with current forms, disclaimers, or other legal text for consensual and surreptitious requests that are made available to the agency service 115.

One example embodiment of the appliance 150 also includes its own interface (not shown) that enables monitoring devices 107 to access real-time and historic location data stored on the appliance for the target device 105. Interfaces provided by the agency service 115 or appliance 150 may also be accessible via a web browser for streaming or downloading data and include the same or similar options.

Additionally, the appliance 150 and agency service 115 may communicate to intermittently update collected data and records at defined intervals or in response to notifications to download data (e.g., in response to a newly received location). During the intervals or notification periods, the agency service 115 may process the data and perform any necessary actions as desired by the monitoring device 107 until the data is transferred to the appliance 150. In some embodiments, the agency service 115 maintains a persistent connection with the appliance 150 to facilitate transfer of real-time location data collected about the target device 105.

In one embodiment, the agency service 115 insures that it, and the CSP 127, do not possess data collected from the target device 105 beyond the time needed to facilitate transfer to the appliance 150. However, in mission critical situations, officers and other agency 110 personnel cannot rely only on the availability of the appliance 150 for storing and maintaining collected data. Consequently, if the appliance 150 is unable to take possession of the collected data or go offline during transfer, the agency service 115 and/or the CSP 127 may maintain possession of the collected data until the appliance 150 is functioning. Furthermore, the agency service 115 and/or CSP 127 may determine whether checksums, hashes or sizes of transferred data match the appliance's 150 version prior to deleting stored data.

In some embodiments, the agency service 115 maintains an appliance instead of, or in addition to, the agency 110. In such cases, the appliance may exist as a dedicated piece of hardware or remote storage. Alternatively, embodiments of the appliance 150 may be implemented in a cloud computing and storage stack available on the network 120.

The network 120 represents the communication pathway between agencies 110, agency service 115, the monitor devices 107, target devices 107, CSP 127, internet 123, provider network 129, GPS network 125 and other entities such as GPS satellites (not shown) in the GPS network 125. In one embodiment, the network 120 includes standard communications technologies and/or protocols and can include the Internet 123 and PSTN. Oftentimes, these communications technologies and/or protocols carry both PSTN and Internet related data. Thus, the network 120 can include links using technologies such as Ethernet, 802.11, worldwide interoperability for microwave access (WiMAX), 2G/3G/4G mobile communications protocols, worldwide interoperability for PSTN communications, digital subscriber line (DSL), asynchronous transfer mode (ATM), InfiniBand, PCI Express Advanced Switching, etc. Similarly, the networking protocols used on the network 120 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 120 can be represented using technologies and/or formats including analog audio (e.g., for last mile PSTN communications), digital audio and video (e.g., as a file or streaming with Real Time Streaming Protocol), the hypertext markup language (HTML), the extensible markup language (XML), JavaScript, VBScript, FLASH, the portable document format (PDF), etc. In addition, all or some of the data exchanged over the network 120 can be encrypted using conventional encryption technologies such as secure sockets layer (SSL), transport layer security (TLS), virtual private networks (VPNs), Internet Protocol security (IPsec), etc. In another embodiment, the entities on the network 120 can use custom and/or dedicated data communications technologies instead of, or in addition to, the ones described above. For example, some government agencies and the military may operate networks auxiliary to the internet and PSTN.

As used herein, the term “module” refers to computer program instructions and/or other logic used to provide the specified functionality. Thus, a module can be implemented in hardware, firmware, and/or software. In one embodiment, program modules formed of executable computer program instructions are stored on a non-transitory storage device, loaded into memory, and executed by a computer processor as one or more processes.

As used herein, the terms “message,” “messaging,” and “short messaging service (SMS)” each comprise the breadth of messaging services and related technologies or standards used for communicating and transmitting data over the network 120. These technologies and services include SMS messages, multimedia messaging service “MMS” messages, proprietary messaging service messages such as BLACKBERRY messages “BBM” and the like.

### Geolocation Module Functionality

FIG. 2 is a block diagram illustrating a geolocation module 141 according to one example embodiment. As mentioned above, a geolocation module 141 may be downloaded from the agency service 115 to the monitoring device 107 of an officer and executed to facilitate communications with the agency service 115 and present data to the officer. Alternatively, the officer may use the monitoring device 107 to access geolocation module 141 functionality via, for example, the agency interface 147 from a web browser. As shown in FIG. 2, the geolocation module 141 itself includes multiple modules. In the embodiment shown in FIG. 2, the geolocation module 141 includes a consented location module 205, surreptitious location module 210, location request module 215, and monitoring dashboard. 220. In some embodiments, the functions are distributed among the modules in a different manner than described herein. Other embodiments have additional and/or other modules.

The consented location module 205 automates the process for geolocating a target device 105 when the officer expects the user of the target device to consent to being geolocated. The consented location module 205 may receive properties associated with the geolocation request from the officer. For example, the officer may provide the transmitting number of the target device 105, the name/alias of the user, and an expiration date. The expiration date specifies the time period (e.g., number of days) the officer is requesting to be able to locate the target device 105. In turn, the consented location module 205 processes the request according to a set of rules governing consensual geolocation requests. For example, the user of the target device may be required to provide explicit consent before the officer may locate the target device. Additionally, in some embodiments, the consented location module 205 may require the officer to confirm (e.g., by consenting to terms and conditions for using the geolocation system) that the user has been informed about the geolocation request process. Additional example rules may govern the maximum length of time a user may consent to a location request and whether the user must be provided an option to terminate the service at any time.

In one embodiment, the user of the target device 105 consents to a geolocation through replying affirmatively to a series of prompts, such as SMS messages, generated by the consented location module 205. The prompts may contain a number of options for the user to select (e.g., by replying back as instructed). One example prompt may request the user to reply back with a “Yes” to approve, “No” to deny, or “Help” to view additional information for the geolocation request. Additionally, one or more prompts may inform the user of one or more properties associated with the geolocation request that were provided by the officer, such as the time period the officer is requesting to be able to locate the user's target device 105.

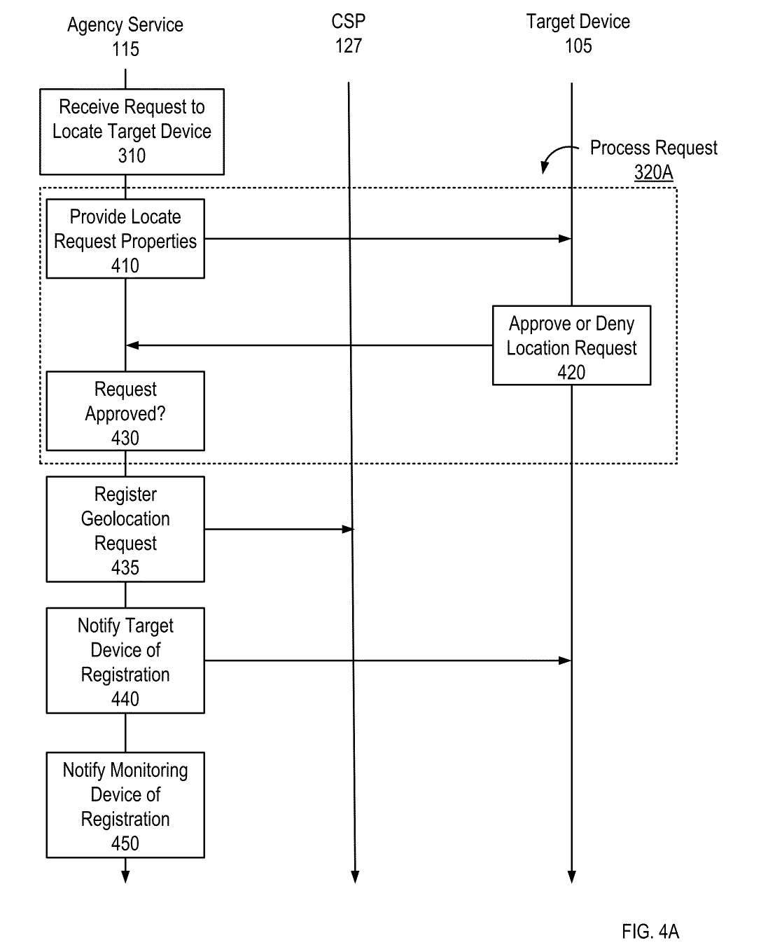

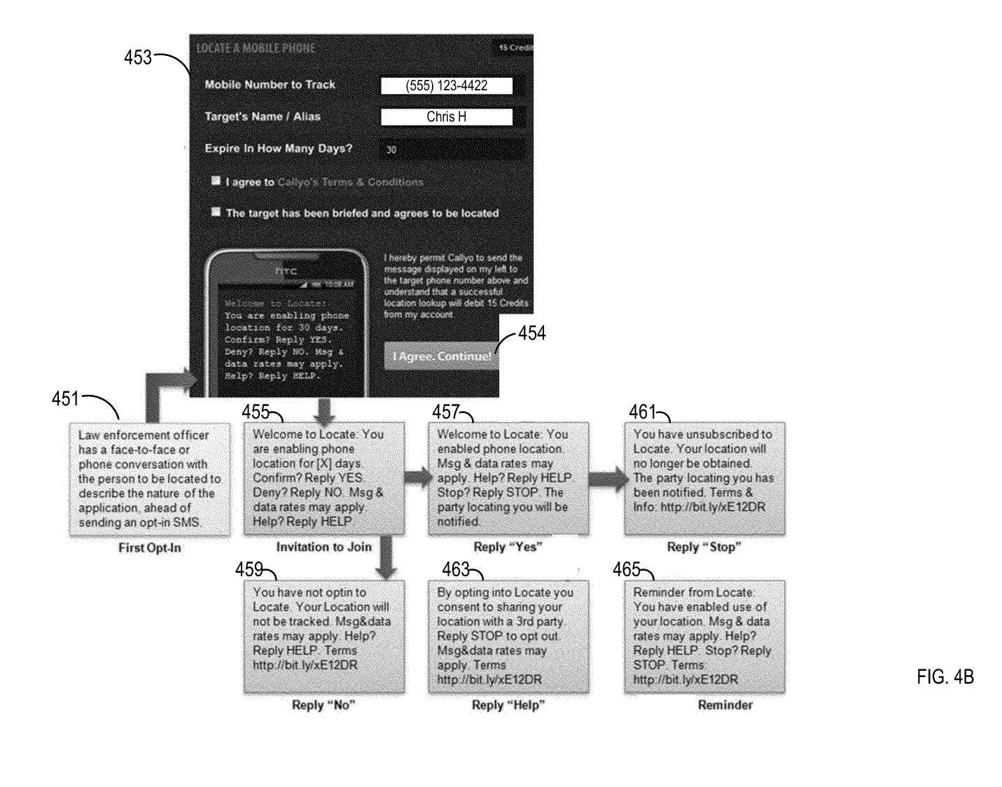

The consented location module 205 parses SMS replies received from the target device 105 to determine which provided option the user selected. Based on the user's selection, the consented location module 205 may generate a follow-up SMS prompt that is transmitted to the target device 105 and optionally notify (e.g., via SMS) a requesting monitoring device 107 of the user's selections. For example, the consented location module 205 may generate a follow-up SMS for the target device 105 providing instructions on how to terminate the service (e.g., reply back with “STOP” to end geolocation) or receive help with the service (e.g., reply back with “HELP” for questions). An example sequence of prompts is described in greater detail with reference to FIG. 4B.

Once the user of the target device 105 provides selections approving the geolocation request, the consented location module 205 registers the request with the CSP 127. For example, the consented location module 205 may register the transmitting number of the target device 105 with the CSP 127 for permitting location based lookups (e.g., from the agency service 115) over X days. In one embodiment, the consented location module 205 registers the request with a location interface 145 of the CSP 127. Additionally, the consented location module 205 stores and updates the properties associated with the geolocation request at the agency service 115 and/or appliance 150 to reflect the user's consent to being located.

The surreptitious location module 210 automates the process for geolocating a target device 105 absent the consent of the user of the target device. The surreptitious location module 210 may receive properties associated with the geolocation request from the officer. For example, the officer may provide a known transmitting number of the target device 105, the name/alias of the user, and an expiration date. The expiration date specifies the time period (e.g., number of days) the officer is requesting to be able to locate the target device 105. In turn, the consented location module 210 processes the request according to a set of rules governing surreptitious geolocation requests. For example, depending on the officer's agency, state, urgency of request, etc., legal documentation may differ and the officer may need to submit supporting legal documentation such as warrants or court orders. Thus, the surreptitious location module 210 may modify generated legal documentation and request applicable supporting documentation based on the set of rules and the officer provided information for the geolocation request. Additionally, in some embodiments, the surreptitious location module 210 may require the officer to confirm (e.g., by consenting to terms and conditions for using the geolocation system) that he understands the legal requirements of submitting a surreptitious geolocation request.

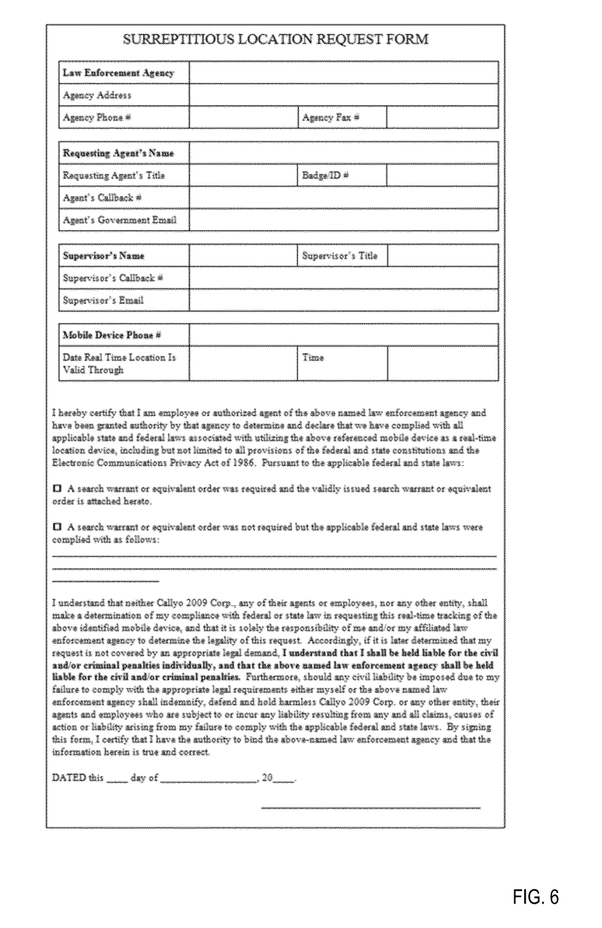

The surreptitious location module 210 subsequently generates a surreptitious request form for the officer. In one embodiment, the surreptitious location module 210 retrieves a blank form from the agency appliance 150 and/or the agency service 115. FIG. 6A is an example form with fields for processing a surreptitious location request, according to one example embodiment.

The surreptitious location module 210 modifies the retrieved form based on the Officer provided properties associated with the request. For example, the surreptitious location module 210 identifies the different fields in the form associated with the properties provided for the location request and automatically generates values for the fields based on the properties. Thus, example form fields such as “transmitting number” and “name/alias” may be automatically populated by the surreptitious location module 210.

Additionally, in some embodiments, the surreptitious location module 210 modifies the retrieved form based on other determined information. For example, an officer may be required to provide login credentials for a unique user account to access the geolocation module 141. The surreptitious location module 210 may identify information about the officer based on the login credentials and, in turn, modify the form based on the identified officer information. The surreptitious location module 210 may identify the officer information associated with provided login credentials at the agency appliance 105 and/or the agency service 115. Information identified about the officer may include the officer's name, agency and/or department, badge number, etc. Further, the information identified about the officer may also include information for a supervisor or other personnel that provides oversight on the legality of location requests.

The surreptitious location module 210 may prompt the officer to provide information for required fields in the form that are not automatically populated. For example, the surreptitious location module 210 may determine that a warrant (or other court order) is required and prompt the officer to indicate whether the warrant has already been issued or is in the process of being obtained. If no warrant is need, the surreptitious location module 210 may prompt the officer to provide an explanation of the circumstances.

Once the surreptitious location module 210 has completed desired modifications of the form, a completed request form is generated and displayed to the officer for approval. In embodiments where the officer specified that a warrant has been obtained, the surreptitious location module 210 may additionally prompt the officer to submit a copy of the document with the completed request form. A warrant may be submitted through the uploading of the document or image (e.g., of the warrant) as an attachment to the request form. For example, the surreptitious location module 210 may prompt the officer to identify the location of the document on the monitoring device 107, the appliance 150 or with a 3^{rd} party (e.g., an electronic system of the court), capture images of the document (e.g., using a camera of a mobile phone or scanner), or indicate that the document will be provide via fax or other means (e.g., email). The surreptitious location module 210 generates a request package including the approved form, request properties, and any supporting documents for the geolocation request that may be stored at the agency appliance 150 and/or agency service 115 for registration with the CSP 127.

If the officer indicated that a warrant or other supporting document for a location request will be provide via fax or other means (e.g., email), the surreptitious location module 210 generates a unique code (e.g., bar code or QR code) that, when included with the supporting documents, identifies the associated request. In some embodiments, the surreptitious location module 210 generates a fax cover sheet including the unique code and instructions (e.g., fax number, attention to, etc.) indicating where the supporting documents should be faxed. In one embodiment, the surreptitious location module 210 may examine supporting documents received at the agency service 115 and/or appliance 150 (e.g., via fax) for unique codes associated with outstanding surreptitious request packages. Once the supporting documentation is identified for an outstanding request, the surreptitious location module 210 stores the completed request package for registration with the CSP 127.

In one embodiment, completed request packages are automatically approved (e.g., by the agency service 115) for registration with the CSP 127. In one embodiment, the surreptitious location module 210 registers the request with a location interface 145 of the CSP 127. For example, the surreptitious location module 210 may register the transmitting number of the target device 105 with the CSP 127 for permitting location based lookups (e.g., from the agency service 115) over X number of days.

In some embodiments, completed request packages are verified, for example, by the agency service 115, a 3^{rd} party, and/or the supervisor of the officer placing the request prior to registration with the CSP 127. Verifications may also be performed in instances where information for the target device 107 is incomplete or is confirmed prior to registering a request. For example, a CSP 127 subscriber list may be queried based on the name/aliases, transmitting number, location, etc., provided by the officer for the user/the target device 107. The agency service 115 may, in turn, compare query results with the information provided by the officer to verify the relationship between a user and a target device 107. If a completed request package requires review by personnel, the surreptitious request module 210 may notify the appropriate party when a completed request package is pending and provide the request package to the party. Once the necessary parties have approved a generated request package, a location request for the indicated target device 107 is registered with the CSP 127. Additionally, generated request packages, in which a geolocation request is registered with the CSP 127, may be stored such that an agency 110 and/or CSP 127 may audit the request and associated package.

The location request module 215 receives officer requests to locate a target device 107 registered with a CSP 127 and, in turn, interfaces with the location interface 145 of the CSP 127 to request the location of the target device 105. Each time a location fix is returned from the CSP 127, the location request module 215 stores the location and associated request information in its database, including but not limited to the Officer submitting the location request, Target Device Number, Name/Alias, Time/Date of Lookup, CSP Name, Latitude and Longitude, Radius (Margin of Error), Velocity, Heading, and Location Determination Method. The location request module 127 may store the location and associated request information at the agency service 115 and/or appliance 150.

Prior to interfacing with the location interface 145 to retrieve the target device's 107 location, the location request module 215 may verify that the authorized time period for locating the target device has not expired or, for consensual requests, that the agency service 115 has not received a “STOP” response from the user of the target device 107.

In one embodiment, the location request module 215 verifies the expiration dates of all outstanding registered target devices against the current date. When the location request module 215 identifies a registered target device having an expiration date later than the current date, the agency service 115 may transmit a “STOP” command to the CSP 127, thus preventing future location requests via the location interface 145. In the case of registered consensual geolocation requests, the location request module 215 may transmit a notification (e.g., and SMS) to the target device 105 and any monitoring device 107 that initiated the geolocation request or requested a location for the target device that the target device's location may no longer be requested. For surreptitious geolocation requests, only monitoring devices 107 may be notified.

Should the officer subsequently request to update the location for an expired target device 105, the location request module 215 may redirect the officer to the consensual or surreptitious location module 205, 210 to resubmit the request. In one embodiment, the location request module 215 transmits previous request information along with the redirection such that applicable properties and/or fields are provided and filled automatically for the officer.

The monitoring dashboard 220 generates the various interfaces which the officer interacts with to perform location requests for registered target device 107 and maps the locations of target devices for display. In one embodiment, the monitoring dashboard 220 presents a login interface for receiving login credentials. The monitoring dashboard 220 authenticates the credentials and generates an interface displaying the target devices 107 registered with the CSP 127 that the officer may request the location of. In one embodiment, the display comprises a table listing information such as the target device number, user name/alias, date of last location request, expiration date, and option to locate the target device. The table may further include a tab the officer may select to locate a new target device.

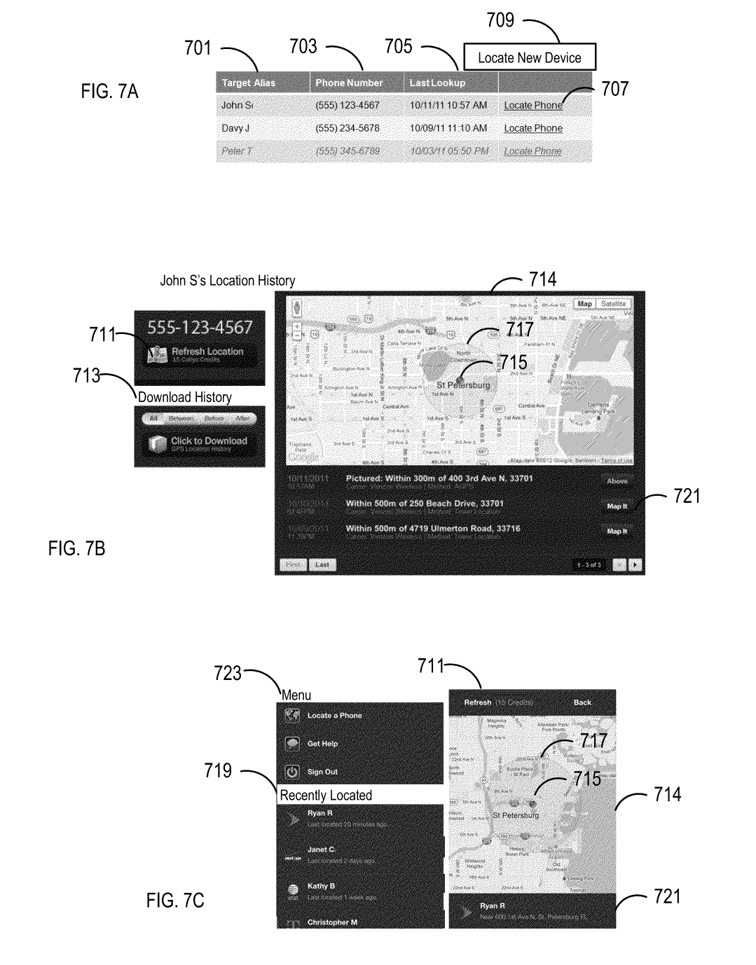

FIG. 7A illustrates an example table of registered devices available for locating, according to one embodiment. The alias 701 of the user of the target device is displayed along with the associated target device number 703 and the last time a location lookup 705 was performed. By selecting locate 707 the officer may view past locations and retrieve the current location for the corresponding target device number 703. Alternatively, the officer may select the location new device 709 option to begin a new geolocation request.

The monitoring dashboard 220 maps the stored locations of selected target devices for display (e.g., in response to officer selection of locate 707). If no historic location information is available, the monitoring dashboard 220 may interface with the location request module 215 to receive a current location. The monitoring dashboard 220 may also provide the officer with the option to refresh the target devices' current location. The monitoring dashboard 220 marks retrieved locations on a map, which may include controls for cardinal directions and zoom level. Retrieved locations may be marked on the map based on coordinates such as latitude and longitude, or other proprietary system. The monitoring dashboard 220 may reverse geocode received coordinates to determine and indicate a nearest address for the marked location. For example, the monitoring dashboard 220 may determine that the coordinates for the mark are “near 1500 Market Street”. In one embodiment, a reverse geocoding service is used to determine nearest address for the marked location. The marked location on the map may include a dot and associated margin of error.

Each marked location may include associated information about the location request. For example, the monitoring dashboard 220 may display the nearest address, the CSP 127 which handled the request, and method (e.g., reported, tower triangulation, and/or GPS) used to determine the location of the target device. In some embodiments, the CSP 129 provides velocity and heading for target device, which may also be indicated on the map.

FIG. 7B illustrates an example interface including marked location of a target device on a map, according to one embodiment. As shown, the interface includes an option for the officer to refresh 711 or update the location of the viewed target device 105. Additionally, the officer may download the location history 713 of the target device, which may include all gathered location information within a specified time frame. The location report summary 721 displays the latest received locations for the target device 105. The officer may choose to map one or more reported locations in a map display area 714. The map display area 714 itself shows the reported locations 715 of the target device 105 and associated margin of error 717. In some embodiments, a heading and speed of the target device are also indicated within the map display area 714.

FIG. 7C illustrates an example interface formatted for a mobile device including marked location of a target device on a map, according to one embodiment. As shown, the interface includes an option for the officer to refresh 711 or update the location 715 of the viewed target device 105. The location report summary 721 displays the last received location for the target device 105, and may be selected to view additional location for mapping. The map display area 714 itself shows the reported locations 715 of the target device 105 and associated margin of error 717. In some embodiments, a heading and speed of the target device are also indicated within the map display area 714. By selecting options within a menu 723, the officer may locate a different device. The interface may further include a list of recently located 719 target devices according, for example, to their user's alias.

In some embodiments, the monitoring dashboard 220 marks the locations of multiple target devices 105 within the map display area 714. For example, the officer may select an option (not shown) to view the table (e.g., that of FIG. 7A) of available registered targets. Each target in the table may further include an associated “Show” or “Hide” button that reveals or removes their reported locations from the map. In one embodiment, clicking Show will generate a new location request to the CSP 127 for the target's current location. In another embodiment, Show will use the last reported location of the target device. Target device markers may be color coded or numbered to distinguish the locations of difference target devices. In some embodiments, the history display for multiple targets includes tabs or other suitable interface elements for selection, refreshing and viewing of the location history for a given target device.

Additionally, the monitoring dashboard 220 may allow the officer to mark additional (e.g., past/current) locations for a target device and/or multiple target devices over a given time period. The markers may be uniformly color coded or otherwise visually distinct for a given target device to provide visual consistency across the target's mapped locations and descriptively tagged (e.g., with a time stamp or subject name). Furthermore, for the locations of a given target that were frequently updated (e.g., on the order of seconds, minutes or hours), the monitoring dashboard 220 may visually link consecutive marks (e.g., by a connecting line that may indicate direction) on the map. Statistics relating to the target devices travel (e.g., average speed, time spent moving/stationary, etc.) between two locations may also be determined by the monitoring dashboard 220 and displayed graphically and/or numerically.

The monitoring dashboard 220 may further configure recurring location requests which cause the location request module 215 to automatically receive the current location of one or more target device 107. After a target device has been registered with the CSP 127, the monitoring dashboard 220 may provide the officer with the option to specify a recurring location request. The monitoring dashboard 220 prompts the officer to specify a desired frequency and time to request the automatic update. For example, the officer may specify that the location of a given target devices is refreshed at 7:00 am every day, every hour from 7 am-8 pm on weekdays, etc. An ending time for the recurring location requests may also be specified, but if not, new locations will not be retrieved after the expiration date (or target device opt out) of the registered request itself. Similar to a manual location request, the monitoring device 220 submits target device information to the location request module 215 which retrieves the current location of the target device.

### Geolocation of a Target Device

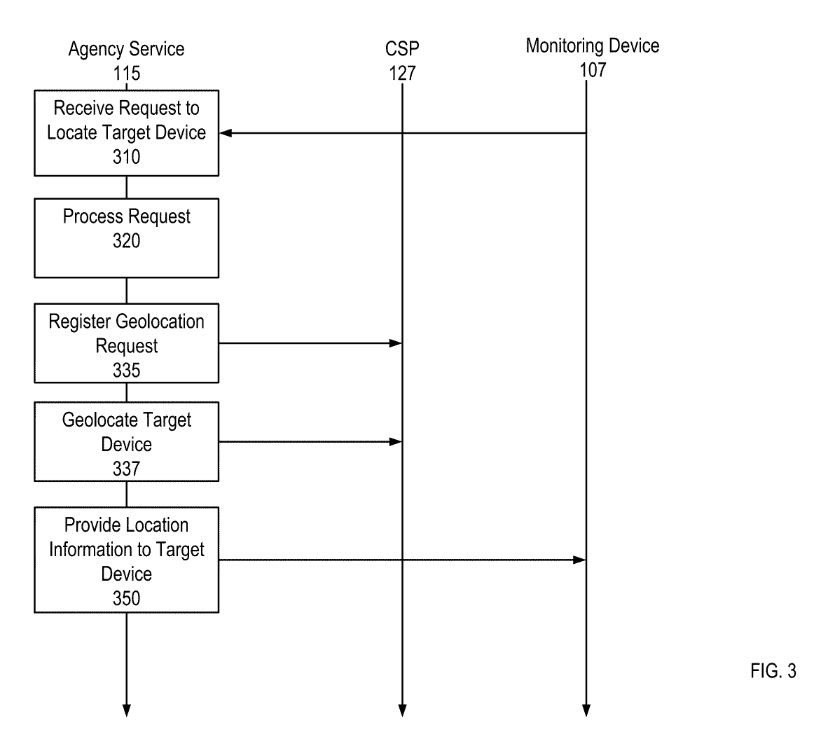

FIG. 3 is an interaction diagram illustrating a method of geolocating a mobile device during the course of a law enforcement operation, according to one example embodiment. Initially, the agency service 115 receives 310 a request to locate a target device from a monitoring device 107. The request may include information about the target device, the user of the target device and whether the user of the target device will be consenting to the location request. The request may further including information about the officer submitting the location request.

If the user of the target device will be consenting to the location request, the agency service 115 processes 320 the request according to a set of rules that legally prompt the user of the target device for consent. For example, the agency service 115 may generate a SMS message prompting the user of the target device to consent to the location request via a SMS reply. The user's affirmative reply completes the request.

If the user of the target device will not be consenting to the location request (i.e., a surreptitious location request), the agency service 115 processes 320 the request according to a set of rules that generate legal documentation ensuring that the officer complies with laws applicable to completing the request. Additionally, the agency service 115 may determine any supporting legal documents that the officer should provide to complete the request and prompts the officer to provide the supporting documentation.

Completed geolocation requests are registered 335 with the CSP 127, which in turn enables the agency service 115 to retrieve the target device's location. To retrieve the target device's location, the agency service 115 submits target device information to the CSP 127 to geolocate 337 the target device.

The agency service 115 subsequently receives location information for the target device and provides 350 the location information to the target device 350. In one embodiment, the agency service 115 provides 350 the location information to the target device via a web browser over the internet. For example, the agency service 115 may mark the received location of the target device on a map, which is rendered by the browser. In another embodiment, the agency service 115 provides 350 the location information to a geolocation module executing on the target device. The geolocation module, in turn, marks the received location of the target device on the map and renders the marked map for display.

FIG. 4A is an interaction diagram illustrating a method of processing 320A a consensual location request, according to one example embodiment. The agency service 115 receives properties associated with the geolocation request 310 from the officer. For example, the officer may provide the transmitting number of the target device 105, the name/alias of the user, and an expiration date for the geolocation request. In some embodiments, the officer may indicate (e.g., by consenting to terms and conditions when submitting the geolocation request) that the user of the target device 105 has been informed about the geolocation request process.

To process 320A the geolocation request, the agency service 115 transmits 410 the properties of the location request and a prompt for the user to approve or deny the location request to the target device 105. The user of the target device 105, in turn, consents to a geolocation request by approving 420 the location request through replying affirmatively to the prompt or series of prompts, such as SMS messages. Alternatively, the user of the target device 105 may deny 420 the location request in the SMS reply or simply not reply at all.

The agency service 430 parses received SMS replies to determine whether the request is approved 430 or denied. In either instance, the agency service 115 may notify the officer (e.g., via SMS message transmitted to the monitoring device) of the response received from the target device 105. In cases where the request is denied, the agency service 115 ends the geolocation process.

If the geolocation request is approved 430, the agency service 115 registers 435 the geolocation request with the CSP 127. In response to registering 435 the geolocation request with the CSP 127, which enables the agency service 115 to retrieve the location of the target device 105, the agency service 115 may notify 440 the target device 105 and the officer's monitoring device that registration is complete and the agency service 115 may be used locate the target device.

FIG. 4B is a flow chart illustrating an example messaging sequence for confirming a target device user's consent to a geolocation request, according to one example embodiment. As shown, the officer may perform a first opt-in 451 where the officer information the user of the target device about the geolocation process.

The agency service 115 generates an interface 453 for the officer to provide properties of the target device and target device user for the geolocation request. The officer submits 454 the request and the agency service 115 generates a prompt 455 inviting the target device 105 user to consent to the geolocation request. The user may reply “NO” 459 to not participate or reply “YES” 457 to enable the officer to locate the target device 105. After the user has replied “YES” 457, the user may reply “STOP” 461 at a later date to unregister the target device 105 from being located.

The user of the target device 105 may also reply “HELP” to receive additional information 463 from the agency service 115 about the geolocation service. In one embodiment, the agency service 115 transmits a reminder 465 to the target device 105 every so many days to prompt the user whether they want to continue with the service.

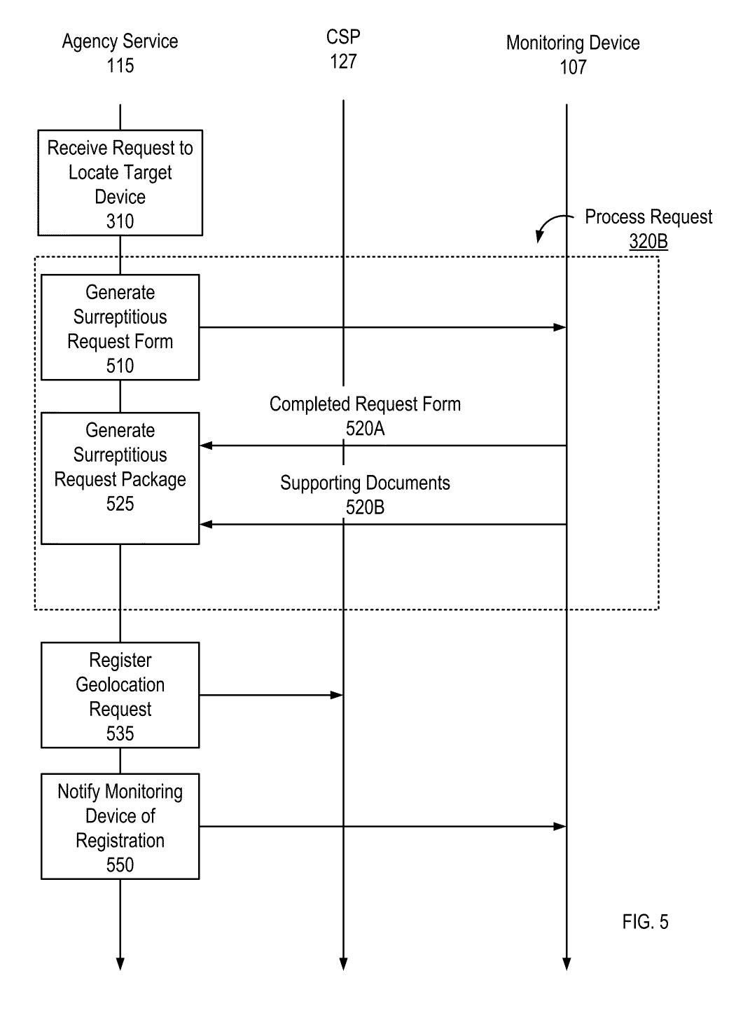

FIG. 5 is an interaction diagram illustrating a method of processing a surreptitious location request, according to one example embodiment. The agency service 115 receives properties associated with the geolocation request 310 from the officer. For example, the officer may provide the transmitting number of the target device 105, the name/alias of the user, and an expiration date for the geolocation request. The offer may additionally indicate that the user of the target device 105 will not be consenting to the location request. For example, in cases whether the user cannot know the target device 105 is being tracked. In some embodiments, the agency service 115 may prompt the officer to confirm (e.g., by consenting to terms and conditions for using the geolocation system) that he understands the legal requirements of submitting a surreptitious geolocation request.

In one embodiment, to process 320B the surreptitious geolocation request, the agency service 115 generates 510 a surreptitious request form. The agency service 115 modifies the retrieved form based on the officer provided properties associated with the request for the target device and user, officer information, and agency 110 policy to meet legal requirements. For example, the agency service 115 may identify the different fields in the form and automatically generates values for the fields based on the properties, officer information, and agency policy. Thus, example form fields such as “transmitting number” and “name/alias” of the target device, Officer and supervisor contact information, and whether a warrant or court order is required may be automatically populated.

The generated 510 form is displayed to the officer on the monitoring device 107. The agency service 115 prompts the officer to complete 520 the necessary fields of the request form. If the agency service 115 determines that a warrant or court order is required, the agency service 115 prompts the officer to provide supporting documentation 520B using the monitoring device. In some embodiments, the agency service 115 may receiver supporting documentation 520 from a source other than the monitoring device 107. In such cases, the agency service 115 may generate a unique code, such as a bar code or quick response (QR) code, that is provided to the monitoring device 107. The officer or another party may, in turn, utilize the unique code to submit supporting documents 520B to the agency service 115 in association with the request.

The agency service 115 verifies completed request forms 520A and supporting documents 520B for the geolocation request 310 and generates 520 a surreptitious location request package 525 including the necessary forms and documentation. In some embodiments, the request package 525 is transmitted to the agency 110, CSP 127, or other entity for approval or auditing. In other embodiments, complete requests package may be automatically approved.

Once a surreptitious request package 525 is complete, the agency service 115 registers 535 the geolocation request with the CSP 127 and notifies the monitoring device of the registration 550.

### SUMMARY

The foregoing description of the embodiments has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A computer based method comprising:
receiving a request to locate a target device associated with a user from a monitoring device associated with an officer, the request including properties identifying a transmitting number of the target device and the user of the target device;
automatically processing the request to locate the target device in accordance with a set of rules governing the legality of locating the target device during the course of a law enforcement operation;
registering the location request with a location interface associated with the target device, the location interface identifying location information for the target device; and
automatically transmitting a location of the target device to the monitoring device.

2. The method of claim 1, wherein automatically processing the request to locate the target device comprises:
prompting the user of the target device to consent to the request to locate the target device.

3. The method of claim 2, wherein prompting the user of the target device to consent to the request to locate the target device comprises:
generating a text message prompting the user of the target device for a response, the text message indicating the request properties;
transmitting the text message to the target device; and
parsing a text message received from the target device to determine whether the user of the target device consents to the request to locate the target device.

4. The method of claim 1, wherein registering the location request with a location interface associated with the target device comprises:
receiving an approval to locate the target device from the user of the target device; and
generating a text message prompting the user of the target device for a response, the text message indicating the request properties.

5. The method of claim 1, wherein automatically processing the request to locate the target device comprises:
automatically generating a legal document for authorizing the request to locate the target device; and
transmitting a prompt to the monitoring device requesting information to complete a field of the legal document in response to a rule in the set of rules governing the legality of locating the target device.

6. The method of claim 5, wherein automatically generating a legal document for authorizing the request to locate the target device further comprises:
identifying fields in the legal document; and
automatically populating one or more fields with the request properties.

7. The method of claim 5, wherein automatically generating a legal document for authorizing the request to locate the target device further comprises:
identifying fields in the legal document;
authenticating login credentials of the officer, the login credentials associated with information identifying the officer; and
automatically populating one or more fields with the information identifying the officer.

8. The method of claim 5, wherein automatically processing the request to locate the target device comprises:
identifying supporting legal documentation for authorizing the officer to locate the target device in response to a rule in the set of rules governing the legality of locating the target device;
transmitting a prompt to the monitoring device requesting the supporting legal documentation; and
generating a location request package including the legal document and the supporting documentation, the location request package registered with the location interface associated with the target device.

9. The method of claim 1, wherein registering the location request with a location interface associated with the target device comprises:
identifying a communications service provider associated with the target device;
registering the request to locate the target device with a location interface of the communications service provider; and
transmitting a geolocation request for the location of the target device, the geolocation request comprising the transmitting number of the target device.

10. The method of claim 1, wherein automatically transmitting a location of the target device to the monitoring device comprises:
receiving coordinates indicating the location of the target device;
marking a map with the location of the target device; and
transmitting the map to the target device.

11. A system comprising:
a server comprising one or more processors and a non-transitory computer-readable storage medium storing computer program code, the computer program code when executed performing steps comprising:
receiving a request to locate a target device associated with a user from a monitoring device associated with an officer, the request including properties identifying a transmitting number of the target device and the user of the target device;
automatically processing the request to locate the target device in accordance with a set of rules governing the legality of locating the target device during the course of a law enforcement operation;
registering the location request with a location interface associated with the target device, the location interface identifying location information for the target device; and
automatically transmitting a location of the target device to the monitoring device.

12. The system of claim 11, wherein automatically processing the request to locate the target device comprises:
prompting the user of the target device to consent to the request to locate the target device.

13. The system of claim 12, wherein prompting the user of the target device to consent to the request to locate the target device comprises:
generating a text message prompting the user of the target device for a response, the text message indicating the request properties;
transmitting the text message to the target device; and
parsing a text message received from the target device to determine whether the user of the target device consents to the request to locate the target device.

14. The system of claim 11, wherein registering the location request with a location interface associated with the target device comprises:
receiving an approval to locate the target device from the user of the target device; and
generating a text message prompting the user of the target device for a response, the text message indicating the request properties.

15. The system of claim 11, wherein automatically processing the request to locate the target device comprises:
automatically generating a legal document for authorizing the request to locate the target device; and
transmitting a prompt to the monitoring device requesting information to complete a field of the legal document in response to a rule in the set of rules governing the legality of locating the target device.

16. The system of claim 15, wherein automatically generating a legal document for authorizing the request to locate the target device further comprises:
identifying fields in the legal document; and
automatically populating one or more fields with the request properties.

17. The system of claim 15, wherein automatically generating a legal document for authorizing the request to locate the target device further comprises:
identifying fields in the legal document;
authenticating login credentials of the officer, the login credentials associated with information identifying the officer; and
automatically populating one or more fields with the information identifying the officer.

18. The system of claim 15, wherein automatically processing the request to locate the target device comprises:
identifying supporting legal documentation for authorizing the officer to locate the target device in response to a rule in the set of rules governing the legality of locating the target device;
transmitting a prompt to the monitoring device requesting the supporting legal documentation; and
generating a location request package including the legal document and the supporting documentation, the location request package registered with the location interface associated with the target device.

19. The system of claim 11, wherein registering the location request with a location interface associated with the target device comprises:
identifying a communications service provider associated with the target device;
registering the request to locate the target device with a location interface of the communications service provider; and
transmitting a geolocation request for the location of the target device, the geolocation request comprising the transmitting number of the target device.

20. The system of claim 11, wherein automatically transmitting a location of the target device to the monitoring device comprises:
receiving coordinates indicating the location of the target device;
marking a map with the location of the target device; and
transmitting the map to the target device.
